(19) United States
(12) Patent Application Publication
(10) Pub. No.: US 2009/0052631 A1
(43) Pub. Date: Feb. 26, 2009

(54) System and Method for Information Embedding and Extraction in Phantom Targets for Digital Radiography Systems

(75) Inventors: Marc Cresens, Diest (BE); Geert Wellens, Kessel (BE); Tom Bertens, Mechelen (BE)

Correspondence Address: HOUSTON ELISEEVA, 4 MILITIA DRIVE, SUITE 4, LEXINGTON, MA, 02421, US

(73) Assignee: AGFA HEALTHCARE NV, Mortsel (BE)

(21) Appl. No.: 12/172,537

(22) Filed: Jul. 14, 2008

Related U.S. Application Data
(60) Provisional application No. 60/956,976, filed on Aug. 21, 2007.

(30) Foreign Application Priority Data
Aug. 20, 2007 (EP) 07114581.7

(51) Int. Cl. G01D 18/00

(52) U.S. Cl. 378/207

(57) ABSTRACT

A system and method for embedding in a phantom target used in digital radiography systems information specific to the phantom target, such as serial number, phantom target type, precision landmarks, composition, physical properties of the dedicated targets and the like. The information is encoded and represented by small holes in the phantom target that can easily and unambiguously be detected by decoding-software acting on the radiation image of the phantom target. A look-up table or any other flexible data structure defines the functionality of the holes detected based on their image-location. Regions of interest can be located based on an internal coordinate system defined accurately by the sub-pixel position of the hole centres.

### RELATED APPLICATIONS

This application claims priority to European Patent Application No. EP07114581.7, filed on Aug. 20, 2007, and claims the benefit under 35 USC 119(e) of U.S. Provisional Application No. 60/956,976, filed on Aug. 21, 2007, both of which are incorporated herein by reference in their entirety.

### BACKGROUND OF THE INVENTION

Image quality performance assessment (QA) and performance control (QC) for digital radiography systems (computed radiography CR or direct radiography DR) are of crucial importance within the context of medical diagnostic imaging. QA/QC testing and reporting of the results for digital X-ray projection image acquisition systems has globally evolved from a moral obligation status towards mandatory requirements, imposed by local health care regulations over the last decade.

Quality control can be performed at several instances during the life-cycle of a digital radiography system. Manufacturers of digital computed radiography equipment can integrate image quality performance testing as part of their final QC-testing procedures, performed prior to customer shipment. Also, hospitals can perform acceptance testing. This acceptance testing relies on the results from image quality performance testing, executed after initial delivery, move, reconfiguration or repair of the image acquisition system or its vital components. Furthermore, periodic quality control testing, also referred to as constancy testing, can be part of a quality assurance program which tracks the image quality performance of computed radiography systems by reporting their time-consecutive QC-results, collected on a regular basis (daily, weekly, monthly, . . . ) to survey the system performance status relative to the image quality requirements and also to gather input for preventive maintenance scheduling.

As shown in FIG. 9 an image acquisition system for computed radiography is composed of various, linked subcomponents e.g. a console, a generator, an X-ray source, a dose monitor (optional) and a detector/digitizer.

The X-ray source is driven by the generator, receiving commands, settings and synchronization from the console. The generator settings, the tube assembly and the external filters, positioned in the beam-path near the X-ray tube, determine the energy spectrum of the generated photons used for projection imaging. An optional dose monitor inside the beam-path can provide accurate exposure information. An absorption shadow of an object (quality control phantom target, patient), present in the optical path during exposure, is projected onto a X-ray sensitive detection surface, external to (storage phosphor medium based for CR) or integrated inside (solid state sensor based for DR) a digitizer.

The detectors used in the digital radiography system may be powder phosphor plates or needle image plates (needle IP), direct radiography detectors (amorphous silicon, amorphous selenium, Cmos, phosphor detector arranged for direct radiography etc.) or the like. A phosphor plate or needle image plate is commonly conveyed in a cassette and is not part of the read out system.

The digitizer converts the object's impinging X-ray shadow, captured and stored by the detector, into a digital image. Additional information, related to the image captured, such as: time, location, system configuration, system settings, imaging mode, exposure conditions, spectrum, dose, . . . , which can be relevant for routing, processing and storage of the generated image can be attached to the image data file. The obtained raw images, if used for medical purposes, are subject to dedicated diagnostic image processing to make them optimally suited for soft- or hardcopy inspection by radiologists or for computer aided detection purposes. The processed images can be visualized, archived, communicated, printed etc. on e.g. a Picture Archiving and Communication System (PACS). An embodiment of a digitizer is described in U.S. Pat. No. 6,369,402.

The scanning technique in the digitizer could be flying-spot or one line at a time. See e.g. R. Schaetzing, R. Fasbender, P. Kersten, “New high-speed scanning technique for Computed Radiography”, Proc. SPIE 4682, pp. 511-520.

The image quality performance testing of the image acquisition system, the front-end of the projection radiography imaging chain, performed during acceptance testing or constancy testing does not require X-ray exposure of human or animal beings.

Image quality performance testing involves acquisition and processing of digital images according to predetermined, well defined procedures and X-ray exposure conditions (sequence, timing, geometry, spectrum, dose, . . . ) by projection imaging one or multiple, dedicated quality control targets, also referred to as phantom targets, positioned in the beam-path between the X-ray source and the detection surface. These QC-targets can be composed of various objects and materials, pattern-wise arranged and spatially distributed inside the target such that the target is optimally suited as a test-object to produce images under exposure conditions, representative for the medical use of the equipment.

The obtained image data and the related information, contained inside the QC-target image, can be processed by dedicated QC-analysis software according to specific algorithms. These algorithms are designed to discriminate and measure the various, characteristic image quality performance parameters, representing the imaging capabilities of the system under test, and relate the calculated performance status to the required image quality criteria, proposed or mandatory for medical use. The QC-test results and comparative findings can be automatically reported and these reports can be archived in a Picture Archiving and Communication System (PACS) or in a dedicated QC-document data base (repository).

Since image acquisition systems for computed radiography are composed of various linked sub-components, the end-resulting image quality performance of the overall system will be determined by the individual image quality performance contributions of the various sub-components, part of the projection imaging chain. Image sharpness for instance, a typical important image quality performance parameter often analyzed, not only depends on the digitizer's modulation transfer function but is also influenced by the selected X-ray tube focus-size and by spatial blurring in the detector-plane. This spatial blurring can occur due to X-ray scatter inside the detector as a function of detector composition and photon spectrum or by strayed stimulation-light during plate-readout (CR).

For this reason overall image quality performance testing often breaks up into multiple, separate QC-tests to evaluate the proper operation of the various system components, each executed under well controlled geometry and exposure conditions according to predetermined and well defined test procedures.

Since the QC-target, a prerequisite to create QC-target images, is an integral part of the image acquisition system during QC-testing, it will, like the other system-components that are part of the imaging chain, have an impact on the properties of the projected target-shadow, of which the QC-target image is generated and of which the image quality performance parameters are derived by calculations.

Image quality performance acceptance criteria are established by QC-analysis of QC-target images, captured from a nominal reference QC-target for each typical, representative system configuration under well controlled exposure conditions. During these tests to establish the reference acceptance criteria for a given image acquisition system only system components showing nominal performance should be part of the imaging chain. These image quality performance acceptance criteria found can be used to evaluate the performance status of a medical diagnostic image acquisition system at the end of the manufacturing chain and out in the field.

The first step in testing is assuring that the input really is what it is supposed to be. Existing systems use bar code labels, or other inserts or add-ons physically attached to the phantom target. The information contained in these artifacts has to be extracted by means of other decoding means and processes. The X-ray image of the phantom target then contains no physically embedded information on the phantom target, and errors cannot be completely excluded.

By accident a wrong phantom target can be used.

The phantom target could be wrongly positioned.

Scanning speed distortions in the fast and in the slow scan directions could lead to not finding or mis-locating the regions of interest (ROIs) and the precision landmarks.

### SUMMARY OF THE INVENTION

The present invention relates to acceptance testing and periodic image quality testing of digital computed (CR) or direct (DR) radiography systems (for a comparison between both, see Robert Bruce, “CR versus DR—what are the options?”, www.auntminnie.com). Both systems will be referred to in the following as digital radiography systems.

More specifically the invention relates to the identification of the phantom target and its characteristics used during quality control of the system. It is of the utmost importance that no errors in this identification nor in the accurate location of the holes are made, since this inevitably affects the relevance and the accuracy of the image quality results analysed.

A phantom target is a dummy target used in an image capturing system to test the behaviour of the system. The phantom target has known characteristics, and it contains clearly detectable sub-targets that each form a region of interest (ROI), and each with characteristics such that the image quality performance can be analysed in all aspects from the phantom target image. See EP 1,369,084 and EP 1,380,259 for examples of phantom targets.

It is an object of the present invention to provide a method for unambiguously identifying the phantom target, the location of its sub-targets and their associated physical properties as well as a method to extract all that embedded information from the phantom target's digital X-ray image.

The above-mentioned effects are realized by a method and system for coding information having the specific features.

In general, according to one aspect, the invention features a method for embedding information in a phantom target for use with digital radiography systems. The method comprises: the information contained in said phantom target being coded; said code being represented by detectable variations in said phantom target; and a flexible data structure governing the functional meaning associated with the presence, absence and physical location of said variations.

In general, according to another aspect, the invention features a system for embedding information in a phantom target for use with digital radiography systems. The system comprises a phantom target containing detectable variations; and a flexible data structure governing the functional meaning associated with the presence, absence and physical location of said variations.

The invention also includes a method and system for extracting information.

In general, according to still another aspect, the invention features a method for extracting physically embedded, encoded information from a phantom target for use with digital radiography systems. The method comprises variations in said phantom target are detected by analyzing the digital image of said phantom target; the geometrical gravity centre of said detected variations is localized by means of sub-pixel geometrical gravity centre determination; and said geometrical gravity centres are checked with a flexible data structure governing the functional meaning associated with the presence, absence and physical location of said variations;

In general, according to still another aspect, the invention features a system for extracting physically embedded, encoded information from a phantom target for use with digital radiography systems. The system comprises a processor for: detecting variations in said phantom target by analyzing the digital image of said phantom target; localizing the geometrical gravity centre of said detected variations by means of sub-pixel geometrical gravity centre determination; and checking said geometrical gravity centres with a flexible data structure governing the functional meaning associated with the presence, absence and physical location of said alterations;

A system and method are provided for embedding information in a phantom target used in quality control of digital radiography systems, the method characterized in that the information contained in said phantom target is coded; said code is represented by detectable alterations in the thickness of the absorbing layer of said phantom target; and a look-up table or other flexible data structure governs the functional meaning associated with the presence, absence and image-location of said alterations.

Another system and method are provided for extracting physically embedded, encoded information from a phantom target used in digital radiography systems, the method characterized in that alterations in the thickness of the absorbing layer of said phantom target are detected by analyzing the digital X-ray image of said phantom target; the geometrical gravity centre of said detected alterations is localized by means of sub-pixel geometrical gravity centre determination; and said geometrical gravity centres are checked with a look-up table or other flexible data structure governing the functional meaning associated with the presence, absence and image-location of said alterations.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a flow chart of the hole detection and the sub-pixel geometrical gravity centre calculation.

FIG. 2 is an example of the encoded information structures in a phantom target.

FIG. 3 illustrates the kernel and masks used in the isotropic gradient calculation.

FIG. 4 illustrates the isotropic gradient image analysis.

FIG. 5 illustrates the background mask and hole mask used in the geometrical gravity centre calculation.

FIG. 6 illustrates the initial geometrical gravity centre ROI.

FIG. 7 illustrates the final geometrical gravity centre ROI.

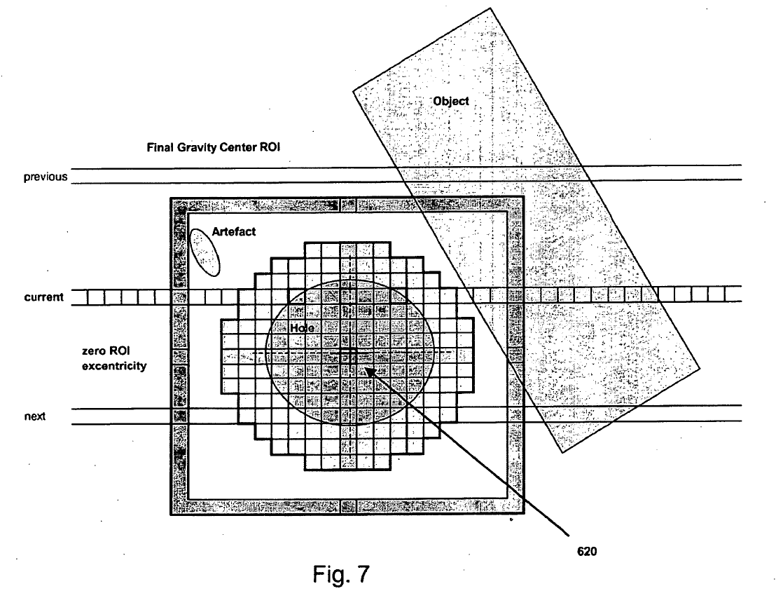

FIG. 8 gives a visualization of ROI signal preprocessing prior to geometrical gravity centre calculation.

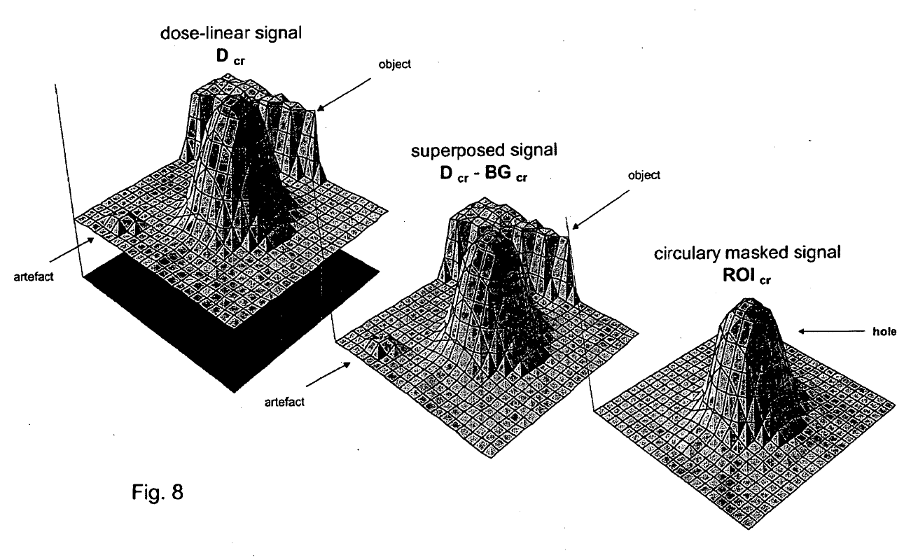

FIG. 9 shows an image acquisition system for computed radiography.

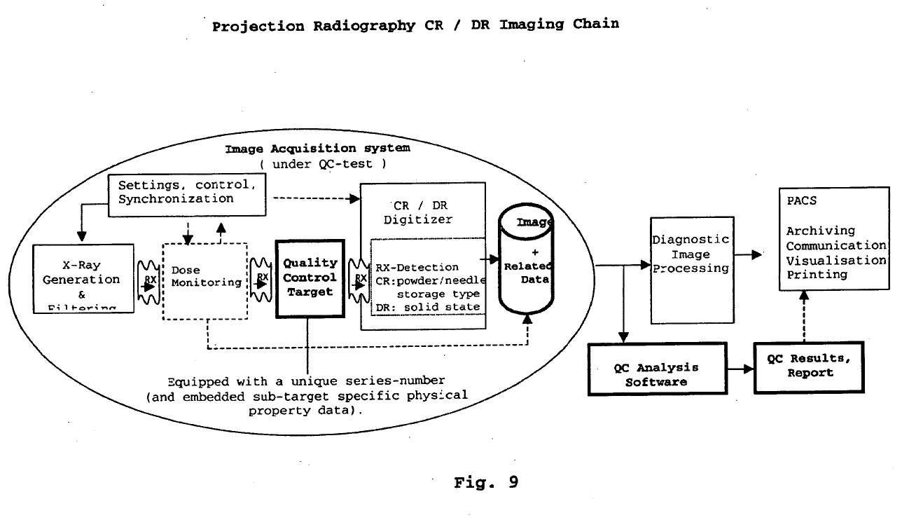

### DETAILED DESCRIPTION OF THE PREFERRED EMBODIMENTS

The current invention addresses above mentioned problems by embedding the necessary information in the phantom target itself, so that it can be automatically recognized and decoded by the analysis software.

Embedding information in the phantom target could be achieved in many ways. It would be possible for instance to change the composition of the material of the phantom target in a controlled and meaningful way, and extract that information from the X-ray image.

The preferred embodiment uses holes drilled in an X-ray absorber layer to encode the information, resulting in a cluster of higher image-signals, i.e. there is less absorption of the incoming X-rays at the location of the holes which is a clear indication that the supposed artifact is artificial. This prevents the detection software from analyzing stains or dust particles on the phantom target since these always will give lower image-signals due to their locally elevated X-ray absorption. In the preferred embodiment the holes are circular and standardized to a predetermined diameter to ease detection. The information is coded in the relative location of the holes, their presence or absence and their sub-pixel geometrical gravity centre image-location (the geometrical gravity centre of an object is the point around which the volume of the object is evenly distributed). These holes must be sufficiently small not to disturb the X-ray image. Circular holes can easily and accurately be drilled at low cost and with a high degree of reproducibility into the phantom target's X-ray absorbing layer by means of Computer Numerical Control (CNC) techniques. Circular holes also cause isotropic image disturbances which again facilitates their detection.

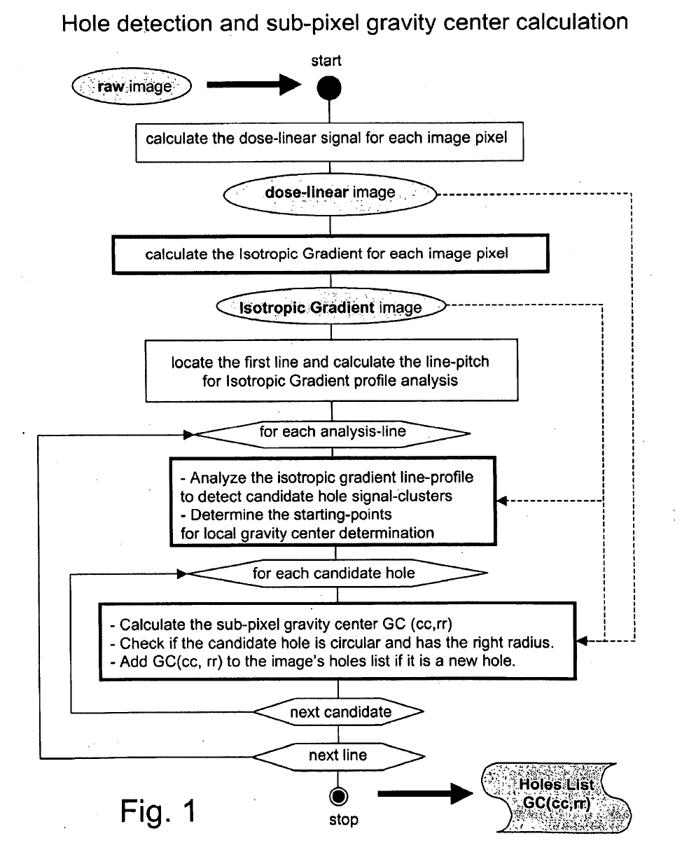

The flow chart for hole detection and sub-pixel geometrical gravity centre calculation is given in FIG. 1, and is described now in more detail.

The first step in interpretation is to scan the digital X-ray image and locate all the holes in the image. First the phantom image is dose-linearised, i.e. the data are decompressed by converting square root or logarithmic to linear, and the zero-dose offset is subtracted. Then the isotropic gradient image is calculated, on which edge analysis can be performed. Knowing that a hole gives a small high contrast spot of low absorption signals on the image, the gradient image will show a small but clear circle indicating the edge of the hole.

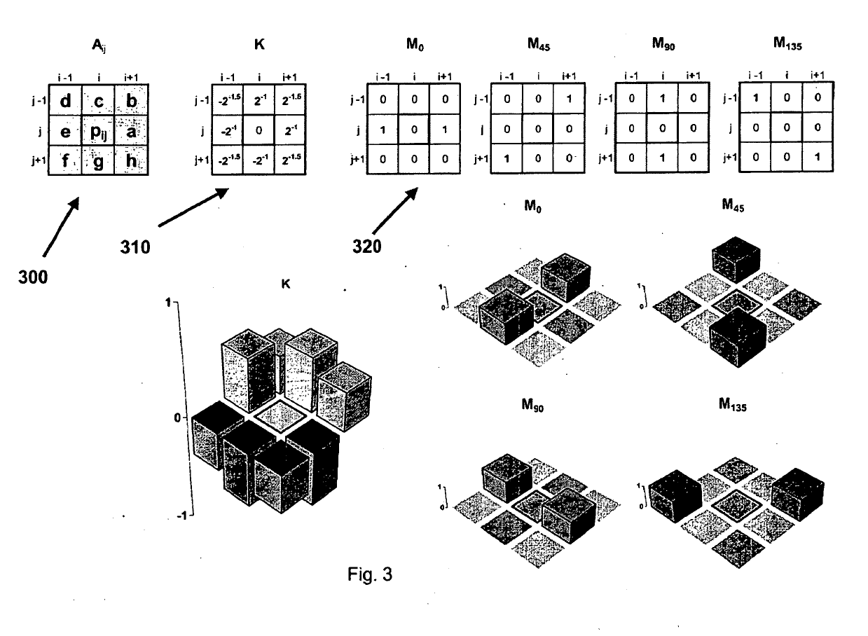

The calculation of said isotropic gradient image is illustrated in FIG. 3. For every pixel in the image a local area 300 is defined as a square containing 9 pixels, the original pixel being its centre. The Local Area Image Data (Aij) of pixel pij at row i and column j is a 3×3 matrix containing the value of the pixel and the values of all its neighbours, where the variables a to h represent the pixel values of the local area:

$${A}_{ij} = ( \begin{matrix}d & c & b \\ e & {p}_{ij} & a \\ f & g & h\end{matrix} )$$

A Spatial Convolution Kernel (K) 310 is defined as a 3×3 matrix and contains the relative weights of every neighbouring pixel. A possible embodiment looks like this:

$$K = ( \begin{matrix}{K}_{d} & {K}_{c} & {K}_{b} \\ {K}_{e} & 0 & {K}_{a} \\ {K}_{f} & {K}_{g} & {K}_{h}\end{matrix} ) = ( \begin{matrix}- {2}^{- 1.5} & {2}^{- 1} & {2}^{- 1.5} \\ - {2}^{- 1} & 0 & {2}^{- 1} \\ - {2}^{- 1.5} & - {2}^{- 1} & {2}^{- 1.5}\end{matrix} )$$

The values Kₐ to Kₕ are chosen such that the difference in distance from the centre is compensated. Thus the values K_{d} and K_{f} are a factor √2 smaller than the values Kₑ and K_{g}, and the values K_{b} and Kₕ are a factor √2 smaller than the values K_{c} and Kₐ.

Four Spatial Convolution Masks (M₀, M₄₅, M₉₀, M₁₃₅) 320 are defined as 3×3 matrices. The subscript indicates the angle of the measuring direction of the mask with the horizontal axis.

$${M}_{0 °} = ( \begin{matrix}0 & 0 & 0 \\ 1 & 0 & 1 \\ 0 & 0 & 0\end{matrix} ) {M}_{45 °} = ( \begin{matrix}0 & 0 & 1 \\ 0 & 0 & 0 \\ 1 & 0 & 0\end{matrix} )$$

$${M}_{90 °} = ( \begin{matrix}0 & 1 & 0 \\ 0 & 0 & 0 \\ 0 & 1 & 0\end{matrix} ) {M}_{135 °} = ( \begin{matrix}1 & 0 & 0 \\ 0 & 0 & 0 \\ 0 & 0 & 1\end{matrix} )$$

The isotropic gradient IGᵢⱼ in pixel pᵢⱼ is now calculated as:

$$I {G}_{ij} = \frac{\begin{matrix}\sqrt{{( {A}_{ij} ⊗ ( K \times {M}_{0} ) )}^{2} + {( {A}_{ij} ⊗ ( K \times {M}_{90} ) )}^{2}} + \\ \sqrt{{( {A}_{ij} ⊗ ( K \times {M}_{45} ) )}^{2} + {( {A}_{ij} ⊗ ( K \times {M}_{135} ) )}^{2}}\end{matrix}}{2}$$

The symbol [symbol] represents matrix convolution, and the symbol × represents the element product of matrix elements.

In this particular embodiment this formula translates to:

$$I {G}_{ij} = \frac{\sqrt{{( a - e )}^{2} + {( c - g )}^{2}} + \sqrt{\frac{{( b - f )}^{2} + {( h - d )}^{2}}{2}}}{4}$$

This isotropic gradient implementation gives a vivid spatial response due to the small kernel size. There is a zero phase shift with regard to the input image due to the centre-symmetrical differentials, and also a good noise filtering due to the use of all the neighbouring pixels, i.e. including the corner pixels of the local area.

This way the isotropic gradient of every pixel in the image is calculated, resulting in an isotropic gradient image. This isotropic gradient image now will be further analysed to determine the centre-position of every hole in the image. Thereto every n^{th} row (or column) of the isotropic gradient image is scanned by the software, where n is chosen such that it is guaranteed that every hole is at least encountered once. This is achieved when the physical distance covered by n rows (or columns) is smaller than the predetermined diameter of the holes. In this particular embodiment this diameter is 1 mm, and the physical distance covered by n rows (or columns) is 0.7 mm. If a hole is encountered a second time, during the edge profile analysis of the next analysis line, it will be regarded as the same hole due to the coincidence of both calculated geometrical gravity centre locations.

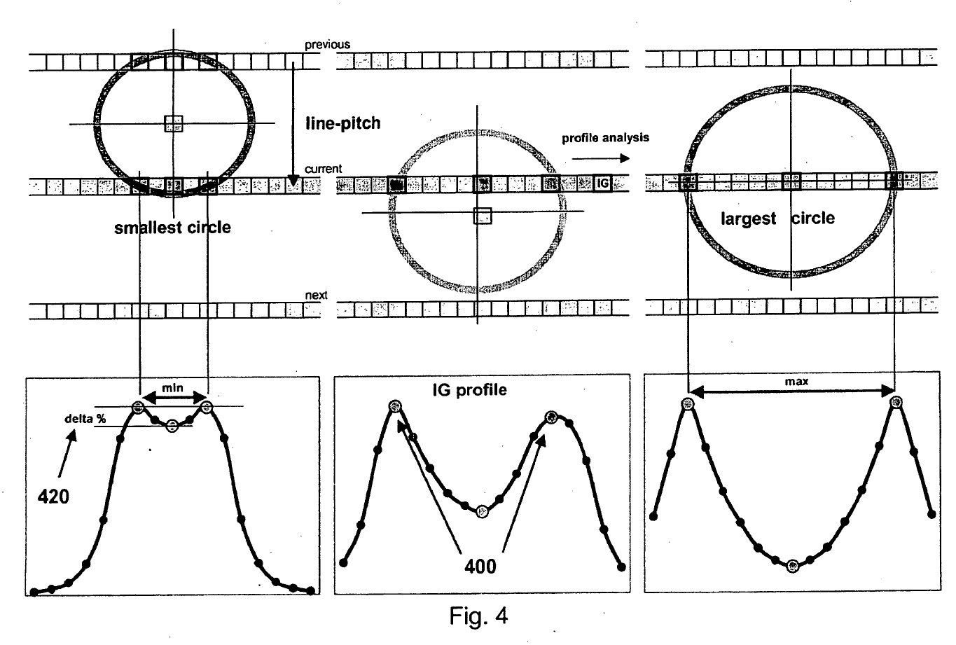

A candidate hole is identified, when the local isotropic gradient line-profile exhibits a typical shape if analyzed along the image line as shown in FIG. 4. The scanning software indicates a hole candidate when the curve of the isotropic gradient shows two maxima 400 less than a hole diameter separated from each other, and a minimum between the two maxima that is at least a certain percentage 420 lower than the maxima. This percentage, again, is chosen such that it is impossible to miss a hole.

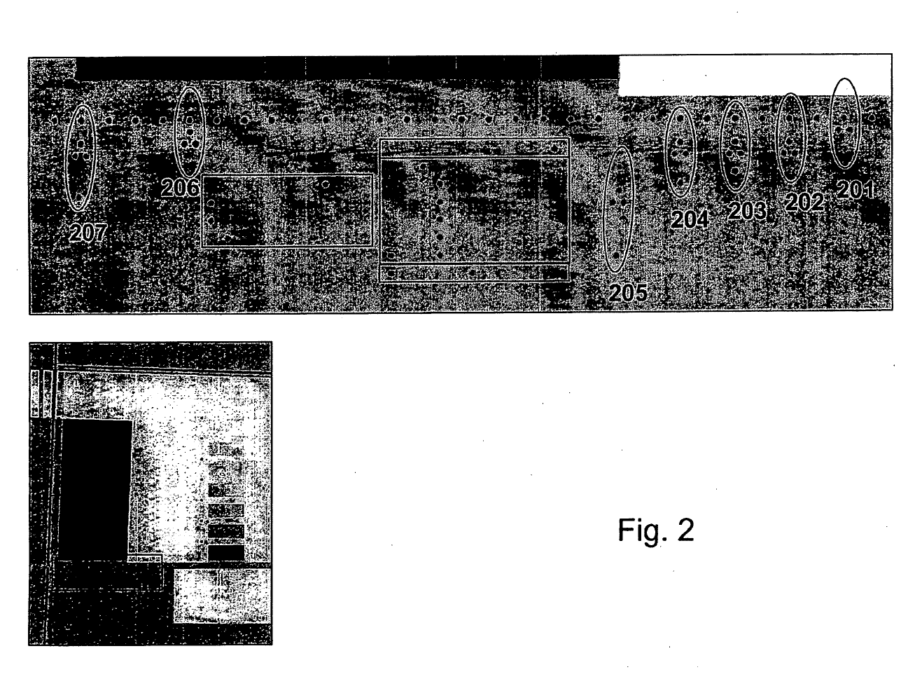

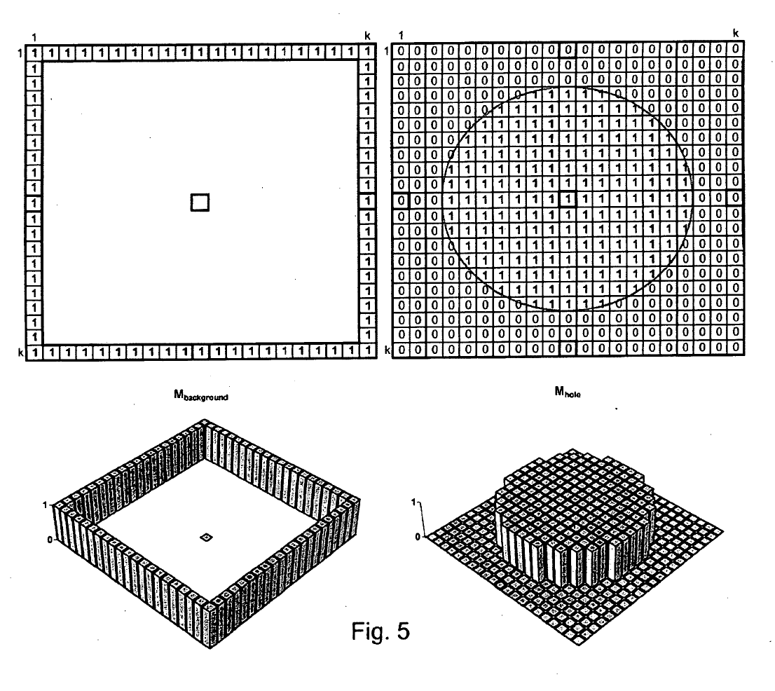

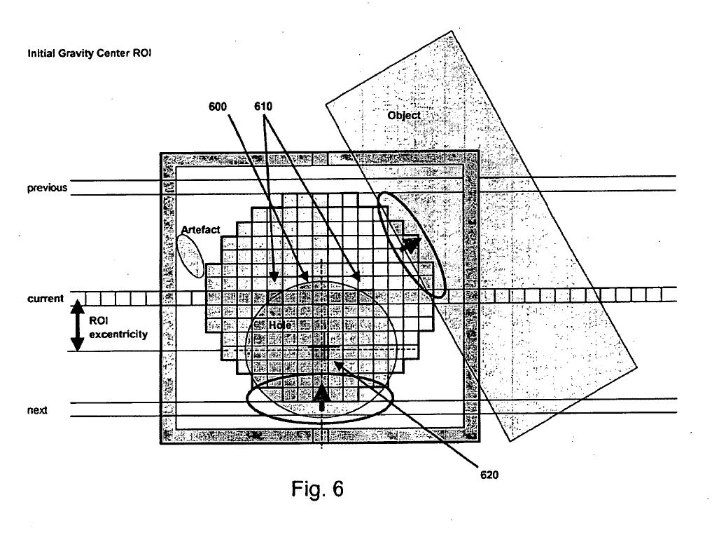

The next step in hole identification is geometrical gravity centre determination, as shown in the flow chart of FIG. 2. Thereto the pixel position at the minimum mentioned above is taken as a first approximation of the geometrical gravity centre of the hole, as shown in FIG. 6. This initial position 600, as the centre of two edge points 610 of the hole, is always located inside the hole. To find the next approximation of the geometrical gravity centre a background mask (M_{background}) is defined around the current approximation as the edge of a square with side k, where k is odd and at least twice the diameter of the hole; see FIG. 5. Since the centre of the square is located within the hole, the hole itself completely resides within the background mask. The background mask only consists of the edge pixels of the square. Said background mask cannot intersect the hole itself or another hole, since the distance between two holes is determined to be at least one hole diameter. Said background mask is used to calculate the median value for the square's border-pixels. The median is chosen above the average to optimally suppress the influence of objects or artifacts that might intersect with the background mask, as shown in FIG. 6. Said median back-ground is consecutively subtracted from the dose-linear image data within the local square area, resulting in the superposed signal.

k=2×(integer fraction of (diameter/pixelsize))+1

Dᵢⱼ=dose-linear Local Area Image Data(k×k matrix)

Also a hole mask (Mₕₒₗₑ) is defined as a circular mask around the current approximation of the geometrical gravity centre with a diameter 1,5 times the diameter of the hole. The hole mask contains all the pixels within this circle. Both hole mask and background mask are clarified in FIG. 5. Note, as can be seen in FIG. 6, that there is no guarantee that the hole is completely contained within the area of the hole mask. The sub-pixel geometrical gravity centre 620 over the hole mask is now calculated by means of a standard 2D geometrical gravity point algorithm.
GC (cc, rr)ᵢⱼ=Sub-Pixel Geometrical Gravity Centre of ROIᵢⱼ.

$$c c = i + {\sum }_{o = 1}^{k} ( o \cdot {\sum }_{p = 1}^{k} {ROI}_{ij} ( o , p ) ) / {\sum }_{o = 1}^{k} ( {\sum }_{p = 1}^{k} {ROI}_{ij} ( o , p ) ) - ( k + 1 ) / 2.$$

$$r r = j + {\sum }_{p = 1}^{k} ( p \cdot {\sum }_{o = 1}^{k} {ROI}_{ij} ( o , p ) ) / {\sum }_{o = 1}^{k} ( {\sum }_{p = 1}^{k} {ROI}_{ij} ( o , p ) ) - ( k + 1 ) / 2.$$

pixGC (c,r)ᵢⱼ=pixel containing GC (cc, rr)ᵢⱼ.
c=integer fraction of (cc).
r=integer fraction of (rr).

If the hole is contained completely within the hole mask, and if there are no disturbing factors as objects or artifacts intersecting with the hole mask, then this newly calculated geometrical gravity centre is the final one. Otherwise more iterations are necessary, producing a converging sequence of geometrical gravity centres by successive approximation. The iteration process stops when the newly calculated geometrical gravity centre lays within the initial, starting pixel or within the pixel that contains the previously determined geometrical gravity centre.

The sub-pixel geometrical gravity centres of the holes detected can be used to accurately locate the spatial landmarks in the phantom image.

When the centres of all holes are identified, the software looks for clusters of three holes in a predefined composition. This composition is called a centroid and consists of an isosceles triangle, the centres of the holes being the corner points.

A centroid defines the local coordinate system directions and senses as follows: the x-axis is collinear with the smaller base of the triangle, and the y-axis is collinear with the line between the top of the triangle and the middle of its base, which means x-axis and y-axis are perpendicular to each other. The positive direction of the y-axis is the direction from the base to the top of the triangle. The positive sense of the x-axis is a quarter-turn rotated clockwise. These local coordinate systems serve as reference points for local information decoding and are the basis for ROI definition.

Each centroid is characterized by a head and a tail. These are collections of holes on the local y-axis at predetermined distances from the centroid. The position of the centre of every hole in head or tail is part of the code. When the software has detected a centroid, it will look for the accompanying head and tail code-parts. Note that head and/or tail of a centroid could be empty. Since the possible locations of holes in head or tail are at a standard distance from each other, head and tail can be read as a binary number, where the presence of a hole represents a binary ‘1’, and the absence of a hole a binary ‘0’.

The decoded information in the head is used as a functional descriptor for the data encoded in the tail. A predefined flexible data structure governs the functional link between the head and the tail information. In the preferred embodiment this data structure is a look-up table.

As an example, consider the encoding as depicted in FIG. 2. A centroid without a head 201 is used to code the phantom type. The tail is interpreted as the binary representation of the type number (“0” in 201, as there are no holes in the tail). A centroid with a head as in 202 points to a sub-target. The tail then specifies the kind of sub-target, i.e.:
0→square
1→rulers
2→step-wedge
4→slits
8→edges
. . .

A centroid with a head as in 206 indicates the serial number of the phantom target, the serial number itself being coded in the rectangular frame adjacent to 206.

It will be recognized that any code scheme would do, and that the particular encoding used in this example is irrelevant to the invention.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for embedding information in a phantom target for use with digital radiography systems, the method comprising:
(a) coding the information contained in said phantom target;
(b) representing said code by detectable variations in said phantom target; and
(c) providing a flexible data structure governing the functional meaning associated with the presence, absence and physical location of said variations.

2. The method of claim 1, wherein the phantom target is used in quality control of digital radiography systems.

3. The method of claims 1, wherein said detectable variations are alterations in the thickness of the absorbing layer of said phantom target.

4. The method of claim 3, wherein said alterations are holes in the absorbing layer of said phantom target.

5. The method of claim 4, wherein said holes all are circular.

6. The method of claim 5, wherein said holes all have the same diameter.

7. The method of claims 4, wherein said holes are drilled into the absorbing layer of the phantom target by means of Computer Numerical Control (CNC) techniques.

8. A method for extracting physically embedded, encoded information from a phantom target for use with digital radiography systems, the method comprising:
(a) detecting variations in said phantom target by analyzing the digital image of said phantom target;
(b) localizing a geometrical gravity centre of said detected variations by means of sub-pixel geometrical gravity centre determination; and
(c) checking said geometrical gravity centres with a flexible data structure governing the functional meaning associated with the presence, absence and physical location of said variations.

9. The method of claim 8, wherein the detection of said variations in step (a) comprises:
(i) the digital image of said phantom target being first dose-linearized and offset subtracted;
(ii) a gradient image of the digital image being calculated;
(iii) edge analysis of the gradient image being performed to establish the starting points for the geometrical gravity centre determination of said variations;
(iv) when a marker candidate is found, the geometrical gravity centre of the variation being determined;
(v) the variation said geometrical gravity centre belongs to then being checked against a set of given conditions that are prerequisites for a variation to be accepted as a marker variation;
(vi) if accepted, the marker variation geometrical gravity centre being added to a marker list if said marker is new, i.e. if it is not contained in said marker list already.

10. The method of claim 9, wherein the gradient image of (ii) is an isotropic gradient image.

11. The method of claims 9, where the set of given conditions of (v) determines that a variation must be a circular hole with a given diameter to be accepted as a marker.

12. A system for embedding information in a phantom target for use with digital radiography systems, the system comprising:
(a) a phantom target containing detectable variations; and
(b) a flexible data structure governing the functional meaning associated with the presence, absence and physical location of said variations.

13. The system of claim 12, wherein the phantom target is used in quality control of digital radiography systems.

14. The system of claims 12, wherein said detectable variations are alterations in the thickness of the absorbing layer of said phantom target.

15. The system of claim 14, wherein said alterations are holes in the absorbing layer of said phantom target.

16. The system of claim 15, wherein said holes all are circular.

17. The system of claim 16, wherein said holes all have the same diameter.

18. The system of claims 15, wherein said holes are drilled into the absorbing layer of the phantom target by means of Computer Numerical Control (CNC) techniques.

19. A system for extracting physically embedded, encoded information from a phantom target for use with digital radiography systems, the system comprising a processor for:
(a) detecting variations in said phantom target by analyzing the digital image of said phantom target;
(b) localizing the geometrical gravity centre of said detected variations by means of sub-pixel geometrical gravity centre determination; and
(c) checking said geometrical gravity centres with a flexible data structure governing the functional meaning associated with the presence, absence and physical location of said alterations.

20. The system of claim 19, wherein the detection in (a) comprises:
(i) the digital image of said phantom target being first dose-linearized and offset subtracted;
(ii) a gradient image of the digital image being calculated;
(iii) edge analysis of the gradient image being performed to establish the starting points for the geometrical gravity centre determination of said variations;
(iv) when a marker candidate is found, the geometrical gravity centre of the variation being determined;
(v) the variation said geometrical gravity centre belongs to being checked against a set of given conditions that are prerequisites for a variation to be accepted as a marker variation;
(vi) if accepted, the marker variation geometrical gravity centre being added to a marker list if said marker is new, i.e. if it is not contained in said marker list already;

21. The system of claim 20, wherein the gradient image of (ii) is an isotropic gradient image.

22. The system of claims 20, where the set of given conditions of (v) determines that a variation must be a circular hole with a given diameter to be accepted as a marker.

23. A computer program product adapted to carry out the steps of claim 1 when run on a computer.

24. A computer readable carrier medium comprising computer executable program code adapted to carry out the steps of claim 1.
